(19) United States
(12) Patent Application Publication
(10) Pub. No.: US 2010/0041808 A1
(43) Pub. Date: Feb. 18, 2010

(54) ARMOUR

(75) Inventors: Simon Canfer, Oxfordshire (GB); Steve Robertson, Oxfordshire (GB)

Correspondence Address: BIRCH STEWART KOLASCH & BIRCH, PO BOX 747, FALLS CHURCH, VA, 22040-0747, US

(73) Assignee: The Science and Technology Facilities Council, Oxford (GB)

(21) Appl. No.: 12/377,813

(22) PCT Filed: Aug. 15, 2007
(86) PCT No.: PCT/GB2007/003113

§ 371 Date: May 5, 2009

(30) Foreign Application Priority Data
Aug. 18, 2006 (GB) 0616494.1

(51) Int. Cl. C08K 3/38

(52) U.S. Cl. 524/404

(57) ABSTRACT

A dough moulding composition for use in the manufacture of ballistic armour comprising a boron carbide particulate and a polymeric binder, wherein the boron carbide particulate exhibits a particle size distribution in which some of the particles have a particle size of 100 μm or more and some of the particles have a particle size of 50 μm or less.

The present invention relates to a dough moulding composition for forming armour plating and the like.

Composite armour panels are known for protection against high energy projectiles such as small arms fire and armour-piercing bullets. One type of armour panel comprises a hard, high density ceramic plate, which is adhered to a bonded laminate of glass cloth or Kevlar cloth. When such an armour panel is struck on the ceramic plate side by a projectile of sufficiently high energy, the ceramic plate shatters and fails, as does the projectile, and the energy of the projectile is delivered to the glass cloth and is dissipated in delamination of the bonded layers of the glass cloth. Ceramic materials useful in this type of armour panel are high temperature fabricated polycrystalline alumina, silicon carbide and boron carbide.

Boron carbide is a very hard material and is also relatively lightweight. It is therefore an ideal candidate material for armour. However, manufacturing shaped articles from boron carbide can be complicated and expensive. The conventional techniques include hot-pressing (pressure sintering) and pressureless sintering.

GB 1283244 relates to a composite armour panel which is made by removing material from at least one surface of a ceramic plate and then adhering the plate to a backing element. For example a layer is removed by grinding from one face of a hot-pressed boron carbide plate and the plate is adhered to a glass cloth laminate by means of an epoxy or polyester resin adhesive.

WO 96/09265 relates to a method of making a boron carbide article by sintering. The method includes mixing boron carbide with an epoxidised resin in solution and drying to form a granulated homogenised mixture. This is followed by a carbonisation cycle in which the mixture is maintained at a constant temperature for a predetermined time.

U.S. Pat. No. 4,005,235 relates to a polycrystalline boron carbide sintered body containing beryllium carbide with a density ranging from 85% to 96% of the theoretical density of boron carbide and having a uniform microstructure of equiaxed grains.

U.S. Pat. No. 4,195,066 relates to a method of producing dense, shaped articles of pure boron carbide that optionally contain 0.1 to 8% by weight of free carbon in the form of graphite. The method involves the steps of homogeneously mixing boron carbide powder with small quantities of a carbon-containing additive, forming the powder mixture into a shaped green body, and then sintering the body in a controlled atmosphere and in the absence of external pressure at a temperature of from 2100-2200° C.

GB-A-2,014,193 relates to dense boron carbide bodies, which are made by the pressureless sintering of a composition comprising boron carbide powder in admixture with carbon powder or with a carbon precursor such as glucose or PVA.

The present invention aim to address or at least mitigate some of the problems associated with the prior art.

Accordingly, the present invention provides a dough moulding composition for use in the manufacture of ballistic armour comprising a boron carbide particulate and a polymeric binder, wherein the boron carbide particulate exhibits a particle size distribution in which at least some of the particles have a particle size of 100 μm or more and at least some of the particles have a particle size of 50 μm or less.

The composition is in the form of a dough, which term also encompasses a putty. The dough can be easily shaped and moulded as required. The dough lends itself to free-forming of complex shapes by, for example, rolling with a rolling pin, cutting with a knife, and shaping with a hand tool. Alternatively, or in conjunction, other plastic moulding techniques such as extrusion or compression or injection moulding may be used.

Preferably, 10 to 40% of the particles have a particle size of 100 μm or more.

Preferably, 40 to 90% of the particles have a particle size of 50 μm or less.

Preferably 15 to 30% of the particles have a particle size of 150 μm or more. More preferably, 15 to 30% of the particles have a particle size of 200 μm or more.

Preferably, 40 to 60% of the particles have a particle size of 20 μm or less.

Preferably, 40 to 60% of the particles have a particle size of 10 μm or less.

The boron carbide particulate preferably exhibits an essentially bimodal particle size distribution, the major modes being centred around the sizes 1 to 40 μm and 150 to 300 μm. Preferably, the major modes are centred around the sizes 1 to 10 μm and 200 to 300 μm.

The particle sizes may be measured according to the FEPA powder size specification.

The range of particle sizes in the boron carbide particulate has been found to facilitate the formation of a dough moulding composition which can be easily shaped, moulded and processed. The range of particle sizes has also been found to minimize the void content in the final body, and therefore to maximize the density of the final boron carbide body. Densities of up to 1.9 gcm⁻³ (80 to 90% of the density of a boron carbide sintered body) can be achieved.

Preferably, the boron carbide particulate comprises 50 to 90 weight % of the composition. More preferably, the boron carbide particulate comprises 60 to 85 weight % of the composition.

The polymeric binder may be any polymeric material that can from a dough when mixed with the boron carbide particulate. It will be appreciated that the polymeric binder will typically be provided in liquid from and may exhibit a range of viscosities. It is also preferable if the binder has a decomposition temperature of less than 1000° C., preferably less than 800° C., more preferably less than 700° C. A preferred binder is an epoxy resin, which will typically be used together with a hardener or curing agent. A suitable example is DGEBA epoxy, which has a number average molecular weight of 700. This may be used with Air Products “Ancamide 506” hardener.

Preferably, the polymeric binder comprises 10 to 50 weight % of the composition. More preferably, the polymeric binder comprises 15 to 30 weight % of the composition.

The composition may further comprise a glass material, for example a glass particulate, preferably glass spheres. In this case, the glass material preferably comprises 10 to 30 weight % of the composition. Bodies produced from such a mix may have improved mechanical properties because the glass acts as a binding agent when the epoxy resin has been burnt off. A suitable glass material is Croxton and Garry Spheriglass 3000.

The composition may further comprises a fibre reinforcement material such as polymer, metallic and/or ceramic fibers. The fibers may be chopped fibers.

The present invention also provides a method for the manufacture of ballistic armour, the method comprising:
(i) providing a dough moulding composition as herein described, optionally including a glass material;
(ii) moulding the composition to a desired shape; and
(iii) heating at least a portion of the moulded composition to drive-off or transform the polymeric binder in said portion.

Accordingly, in order to produce a boron carbide body, boron carbide powder (having the required particle size distribution) is mixed with, for example, an epoxy resin. The boron carbide powder may be mixed with the epoxy resin using a high shear mixer until a dough moulding composition is produced. The high shear mixer ensures that the boron carbide particles are coated with the epoxy resin binder.

A sizing or primer on the surface of the boron carbide may be used to increase bond strength.

The doughy composition can then be moulded into the desired shape/applied to the appropriate surface requiring armour protection. The epoxy resin is then burnt off (or substantially burnt off) in a furnace. Following this step, it will be appreciated that there may still be some residual free carbon from the epoxy resin.

Step (iii) may be carried out in air or an oxygen-containing environment. A more effective oxidation heat-treatment can be achieved by using an oxygen-rich atmosphere.

Step (iii) is preferably carried out a temperature of 400 to 700° C., more preferably 550 to 650° C. The polymeric binder is preferably chosen so that it decomposes at this temperature. The preferred temperature at which the material is heated means that the process is not a high-temperature sintering process. This is to be contrasted with many of the prior art methods.

In one preferred embodiment, the dough composition in step (i) comprises a boron carbide particulate and a polymeric binder, and step (iii) results in the removal (or substantial removal) of the polymeric binder and the formation of boron oxide from at least some of the boron carbide.

In another preferred embodiment, the dough composition in step (i) comprises a boron carbide particulate, a glass particulate and a polymeric binder, and step (iii) results in the removal (or substantial removal) of the polymeric binder, the formation of boron oxide from at least some of the boron carbide, and the melting of the glass particulate.

The heating in step (iii) may be non-uniform. In other words, a greater amount of heat may be applied to one portion of the material than another portion of the material. For example, the outer surface of the material may be heated, while the inner surface is maintained at a lower temperature. This is advantageous because it can result in compositional variations in the material and therefore graded mechanical properties. For example, if the heating in step (iii) is non-uniform, then the polymeric binder may not be removed (or removed only to a limited extent) in certain portions of the moulded dough composition. These portions will tend to have a lower hardness than portions from where the binder has been removed.

Accordingly, the present invention also provides a ballistic armour article formed from a composite material comprising boron carbide, a polymeric material, and boron oxide, wherein the article has an outer surface and an inner surface, and wherein the outer surface contains little or no polymeric material, and wherein the inner surface contains little or no boron oxide.

The present invention also provides a ballistic armour article formed from a composite material comprising boron carbide, a polymeric material, and a glass material, wherein the article has an outer surface and an inner surface, and wherein the outer surface contains less polymeric material than the inner surface. The outer surface preferably contains more glass material than the inner surface. As outlined above, heating just one side of the material will result in the formation a hard glassy matrix on only that surface of the material. If the other side of the material is in contact with a cooled surface or a heat sink, then the polymeric binder (eg epoxy) will remain in that surface. This means that the final armour article will have graded mechanical properties: the glassy matrix is harder than the polymer matrix.

The method according to the present invention may further comprise providing a substrate material for the moulded dough composition. Examples of substrates include metallic substrates such as steel, aluminium and titanium, ceramic and glass substrates, and flexible woven substrates. The moulded dough composition may be laminated to the substrate by the use of, for example, an adhesive, for example a silicon-based adhesive.

Although the present invention has been described in relation to ballistic armour material, it should be noted that the dough moulding composition and the method outlined above are also applicable to neutron shielding materials/neutron absorbing materials In this case, the boron-10 isotope is preferably used because boron-10 is very effective at stopping thermal neutrons. Firing the doughy mix can reduce the epoxy content and burn off hydrogen contained in the epoxy. This is beneficial as the hydrogen nuclei are the same mass as the neutrons and scatter the neutrons hence reducing the number of neutrons absorbed by the boron and thereby increasing detector noise. However, in other applications the hydrogen content may be beneficial since it slows down fast neutrons to a speed where they are more readily absorbed by the boron.

### EXAMPLES

Particle size distribution according to Federation of European Producers of Abrasive Products, FEPA.

| Boron Carbide | 3% max. larger | 94% min larger |
|---|---|---|
| (FEPA grit | than, | than, |
| size) | (micrometres) | (micrometres) |
| F60 | 300 | 212 |
| F60 and finer | 172 | 57 |
| F360 | 40 | 12 |
| F1200 | 7 | 1 |

FEPA powder size specification: The 3% and 94% limits fix the relative slope of the size distribution curve for a particular size determined by, for example, photosedimentromety.

Epoxy formulation: DGEBA epoxy, number average molecular weight 700, with Air Products “Ancamide 506” hardener.

### Processing Methods

### Dough Mix 1

### Composition: B4C/Epoxy

| Material | Parts by weight |
|---|---|
| B4C F60 | 18 |
| B4C F60 + finer | 2.7 |
| B4C F360 | 21.8 |
| B4C F1200 | 39.4 |
| Epoxy resin and | 20 |
| hardener, premixed. | |

Boron carbide particles are weighed and mixed by hand using a spatula. Epoxy resin and hardener are mixed separately at manufacturers recommended ratios, in this case DGEBA:Ancamide 506 100:55 parts by weight. The epoxy is mixed by hand with a spatula for 2 minutes and then degassed to remove trapped air in a vacuum chamber to typically 1 mbar pressure. The epoxy mixture is weighed into the boron carbide and stirred with a spatula. Full mixing is subsequently performed using a Winkworth Z-blade type high shear mixer, until a uniform dough consistency is achieved, typically 3 minutes at ambient temperature.

The dough may be processed by compression moulding as follows: pack into an aluminium mould and cure at a temperature of between ambient and 100° C. for times between 30 minutes and 24 hours (optimally 80° C. for 1 hour) under a pressure of 0.1 to 10 MPa (optimally 10 MPa).

The dough lends itself to free-forming of shapes by rolling with a rolling pin, cutting with a knife, and shaping with any hand tool. Alternatively injection moulding or extrusion could be used (with due regard to the abrasive nature of the material).

### Mix 1A: Boron-Oxide Matrix

To form an epoxy-free material, a heat treatment step can be used to form boron oxide. For example, the following heat-treatment may be used: heat at a rate of 50-200° C./hour (optimally 100° C./hour) to 600° C. in air.

### Dough Mix 2

### Composition: B4C/Epoxy/Glass Powder

This composition corresponds to the above composition but with the addition of 20 parts by weight of glass spheres, “Croxton and Garry Spheriglass 3000”. The processing of the material is as above with the addition of a step to remove epoxy resin and melt the glass. For example, the following heat-treatment may be used: heat at a rate of 100-300° C./hour (optimally 300° C./hour), to 600° C. in air.

1-29. (canceled)

30. A dough moulding composition for use in the manufacture of ballistic armour comprising a boron carbide particulate and a polymeric binder, wherein the boron carbide particulate exhibits a particle size distribution in which some of the particles have a particle size of 100 μm or more and some of the particles have a particle size of 50 μm or less.

31. A dough moulding composition as claimed in claim 30, wherein the boron carbide particulate exhibits an essentially bimodal particle size distribution, the major modes being centred around the sizes 1 to 40 μm and 150 to 300 μm.

32. A dough moulding composition as claimed in claim 30, wherein the boron carbide particulate comprises 50 to 90 weight % of the composition.

33. A dough moulding composition as claimed in claim 30, wherein the polymeric binder comprises 10 to 50 weight % of the composition.

34. A dough moulding composition as claimed in claim 30, wherein the polymeric binder comprises an epoxy resin.

35. A dough moulding composition as claimed in claim 30, wherein the composition further comprises a glass material.

36. A dough moulding composition as claimed in claim 35, wherein the glass material comprises a glass particulate, preferably glass spheres.

37. A dough moulding composition as claimed in claim 35, wherein the glass material comprises 10 to 30 weight % of the composition.

38. A dough moulding composition as claimed in claim 30, wherein the composition further comprises a fibre reinforcement material.

39. A method for the manufacture of a ballistic armour composite material, the method comprising:
(i) providing a dough moulding composition as defined in claim 30, optionally including a glass material;
(ii) moulding the composition to a desired shape; and
(iii) heating at least a portion of the moulded composition to drive-off or transform the polymeric binder in said portion.

40. A method as claimed in claim 39, wherein step (iii) is carried out in air or an oxygen-containing environment.

41. A method as claimed in claim 39, wherein step (iii) is carried out a temperature of from 400 to 700° C.

42. A method as claimed in claim 39, wherein the dough composition in step (i) comprises a boron carbide particulate and a polymeric binder, and wherein step (iii) results in the removal of the polymeric binder and the formation of at least some boron oxide from the boron carbide.

43. A method as claimed in claim 39, wherein the dough composition in step (i) comprises a boron carbide particulate, a glass particulate and a polymeric binder, and wherein step (iii) results in the removal of the polymeric binder, the formation of at least some boron oxide from the boron carbide, and the melting of the glass particulate.

44. A method as claimed in claim 39, wherein the heating in step (iii) is non-uniform.

45. A method as claimed in claim 44, wherein the heating in step (iii) is non-uniform so that the polymeric binder is not removed or removed only to a limited extent in certain portions of the moulded dough composition.

46. A method as claimed in claims 39, further comprising providing a substrate material for the moulded dough composition.

47. A ballistic armour article formed from a composite material comprising boron carbide, a polymeric material, and boron oxide, wherein the article has an outer surface and an inner surface, and wherein the outer surface contains little or no polymeric material, and wherein the inner surface contains little or no boron oxide.

48. A ballistic armour article formed from a composite material comprising boron carbide, a polymeric material, and a glass material, wherein the article has an outer surface and an inner surface, and wherein the outer surface contains a lower proportion of the polymeric material than the inner surface.

49. A ballistic armour article as claimed in claim 48, wherein the outer surface contains a greater proportion of the glass material than the inner surface.
